(19) United States
(12) Patent Application Publication
(10) Pub. No.: US 2026/0264745 A1
(43) Pub. Date: Sep. 10, 2026

(54) DUAL-TOOTHED TRANSMISSION WHEEL FOR STEERING ACTUATOR

(71) Applicant: Schaeffler Technologies AG & Co. KG, Herzogenaurach (DE)

(72) Inventors: Alexandre Camilo, Rochester Hills, MI (US); Andrew Lanni, Ray Township, MI (US); Christopher Colarusso, Detroit, MI (US); Timothy Jacques, Madison Heights, MI (US); Jesus Alejandro Vanzzini Angulo, Irapuato (MX)

(73) Assignee: Schaeffler Technologies AG & Co. KG, Herzogenaurach (DE)

(21) Appl. No.: 19/561,971

(22) Filed: Mar. 10, 2026

Related U.S. Application Data
(60) Provisional application No. 63/769,238, filed on Mar. 10, 2025.

(51) Int. Cl. B62D 5/04; F16H 7/02

(52) U.S. Cl. CPC B62D 5/0445; B62D 5/0424; F16H 7/023

(57) ABSTRACT

A vehicle steering system is provided that includes: a first actuator drivably connected to a threaded nut via a first endless drive band and a dual-toothed wheel; a second actuator drivably connected to the threaded nut via a second endless drive band and the dual-toothed wheel; and, a threaded spindle configured to move linearly along an axis via rotation of the threaded nut. The dual-toothed wheel includes two axially adjacent tooth arrangements that receive each of the respective first and second endless drive bands.

### CROSS REFERENCE TO RELATED APPLICATIONS

This application claims priority to U.S. Provisional Application 63/769,238 filed Mar. 10, 2025, the entire disclosure of which is incorporated by reference herein.

### TECHNICAL FIELD

The disclosure relates to a vehicle steering system for a steer by wire vehicle, and, more particularly, to a toothed transmission wheel incorporated therein.

### BACKGROUND

Steer by wire systems eliminate physical connection between a steering wheel and the wheels of a car and often employ linear actuators that utilize electric motors and screw drives.

### SUMMARY

An example embodiment of a vehicle steering system includes a first actuator, a second actuator, a threaded spindle, a transmission wheel, a first endless drive band, and a second endless drive band. The first actuator and the second actuator are drivably connected to a threaded nut. The threaded spindle moves linearly along a first axis via rotation of the threaded nut. A transmission wheel is fixed to the threaded nut so that the transmission wheel and the threaded nut rotate in unison about the first axis. The first endless drive band rotatably connects the first actuator to the transmission wheel, and the second endless drive band rotatably connects the second actuator to the transmission wheel. At least one endless drive band stop is disposed on the transmission wheel axially between the first endless drive band and the second endless drive band. The at least one endless drive band stop limits axial movement of one or both of the first endless drive band and the second endless drive band. The transmission wheel includes a first plurality of teeth and a second plurality of teeth that extend circumferentially around the transmission wheel. The first plurality of teeth are drivably engaged with the first actuator via the first endless drive band, and the second plurality of teeth are drivably engaged with the second actuator via the second endless drive band. The first plurality of teeth may be axially spaced from the second plurality of teeth on the transmission wheel.

In an example embodiment, the at least one endless drive band stop is arranged axially between the first plurality of teeth and the second plurality of teeth.

In an example embodiment, the transmission wheel includes a through-bore and the threaded nut is disposed partially within the through-bore and extends axially outside of the through-bore.

In an example embodiment, a first end of the transmission wheel receives the first endless drive band and a second end of the transmission wheel receives the second endless drive band. In a further aspect, the first and second ends of the transmission wheel are flangeless.

In an example embodiment, the threaded nut is constructed in one piece with an inner raceway of a rolling element bearing. In a further aspect, the threaded nut includes a ball recirculation system that is arranged radially between a tubular portion of the threaded nut and the transmission wheel. The ball recirculation system may be disposed partially within the through-bore and extends axially outside of the through-bore.

In an example embodiment, a position sensor target is fixed to or disposed at a first end of the transmission wheel and the ball recirculation system is disposed at a second end of the transmission wheel.

In an example embodiment, the transmission wheel is a dual-toothed transmission wheel having a first plurality of circumferentially extending teeth and a second plurality of circumferentially extending teeth axially separated from the first plurality of circumferentially extending teeth. In a further aspect, an axially outer end of the first plurality of circumferentially extending teeth is open and an axially inner end of the first plurality of circumferentially extending teeth is closed.

An example embodiment of a vehicle steering system includes a first electric motor, a second electric motor, a threaded spindle, a driven pulley, a first belt, and a second belt. The first and second electric motors are drivably connected to a threaded nut. The driven pulley is fixed to the threaded nut such that the driven pulley and the threaded nut rotate in unison. The first belt drivably connects the first electric motor to the driven pulley and the second belt drivably connects the second electric motor to the driven pulley. In a further aspect, the vehicle steering system also includes a first drive pulley fixed to the first electric motor and a second drive pulley fixed to the second electric motor. The first drive pulley and the second drive pulley rotatably drive the driven pulley via the respective first belt and second belt. In an example embodiment, the first drive pulley is concentric with the second drive pulley.

In an example embodiment, the threaded nut is located within a bore of the driven pulley.

In an example embodiment, the driven pulley has a tubular body. A first plurality of teeth that rotatably engage the first belt are arranged at a first end of the tubular body, and a second plurality of teeth that rotatably engage the second belt are arranged at a second end of the tubular body.

In an example embodiment, the driven pulley includes a non-driven land disposed axially between the first plurality of teeth and the second plurality of teeth.

In an example embodiment, the first drive pulley includes a first stop configured to limit axial motion of the first belt in the first axial direction, and the second driven pulley includes a second stop configured to limit axial movement of the first belt in a second axial direction.

### BRIEF DESCRIPTION OF THE DRAWINGS

FIG. 1 is a cross-sectional view of an example embodiment of a vehicle steering system for a steer by wire vehicle.

FIG. 2 is a detailed view taken from FIG. 1.

FIG. 3 is a perspective view of a transmission incorporated within the vehicle steering system of FIG. 1.

FIG. 4A is a perspective view of an example embodiment of a dual-toothed wheel of the transmission of FIG. 3.

FIG. 4B is a cross-sectional view taken from FIG. 4A.

FIG. 4C is front view of the dual-toothed wheel of FIG. 4A.

FIG. 5 is an exploded perspective view of the vehicle steering system of FIG. 1.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

The terms “driver wheel” and “driven wheel” are utilized within this disclosure which designate, respectively, a wheel that is connected to a power source, such as an actuator or electric motor, and a wheel that is rotated by the driver wheel via an endless drive band. It could also be stated that the driven wheel is powered via the driver wheel.

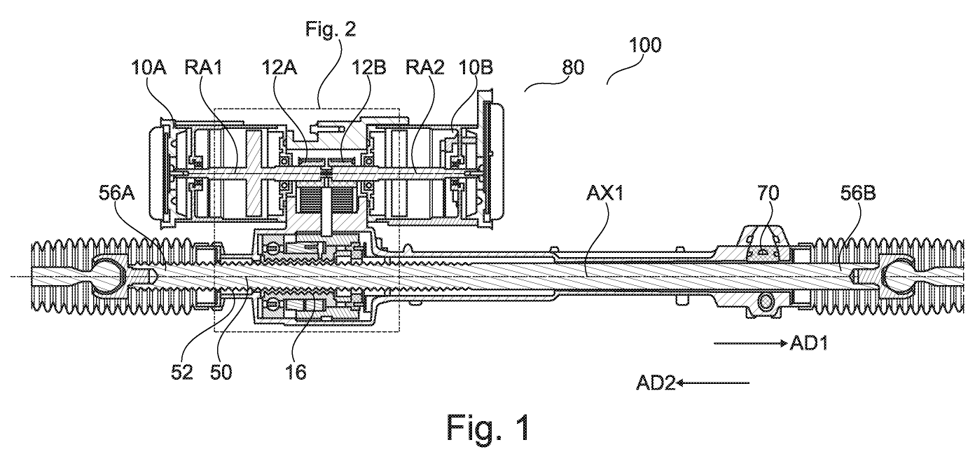

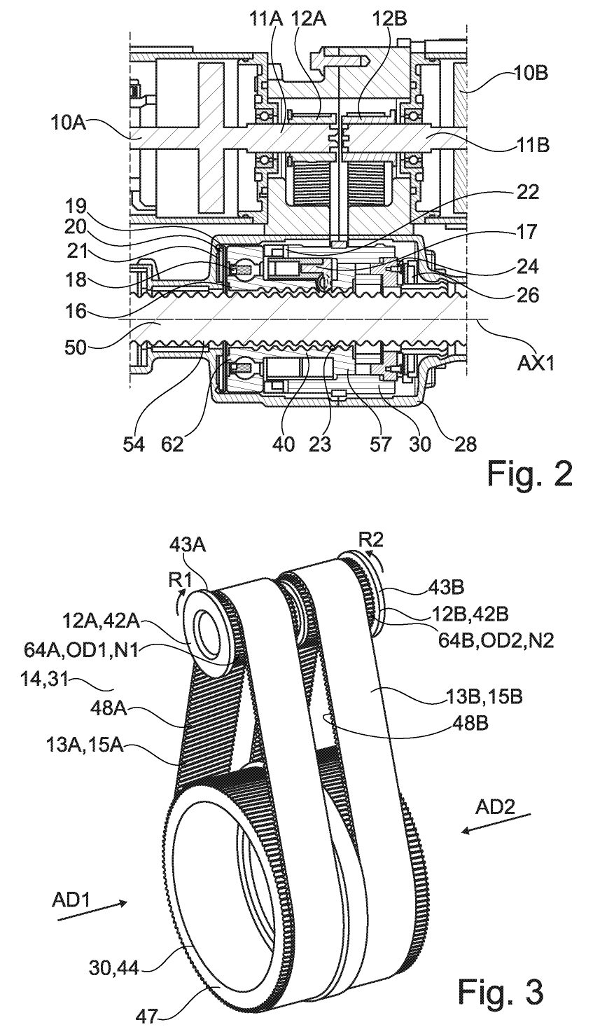

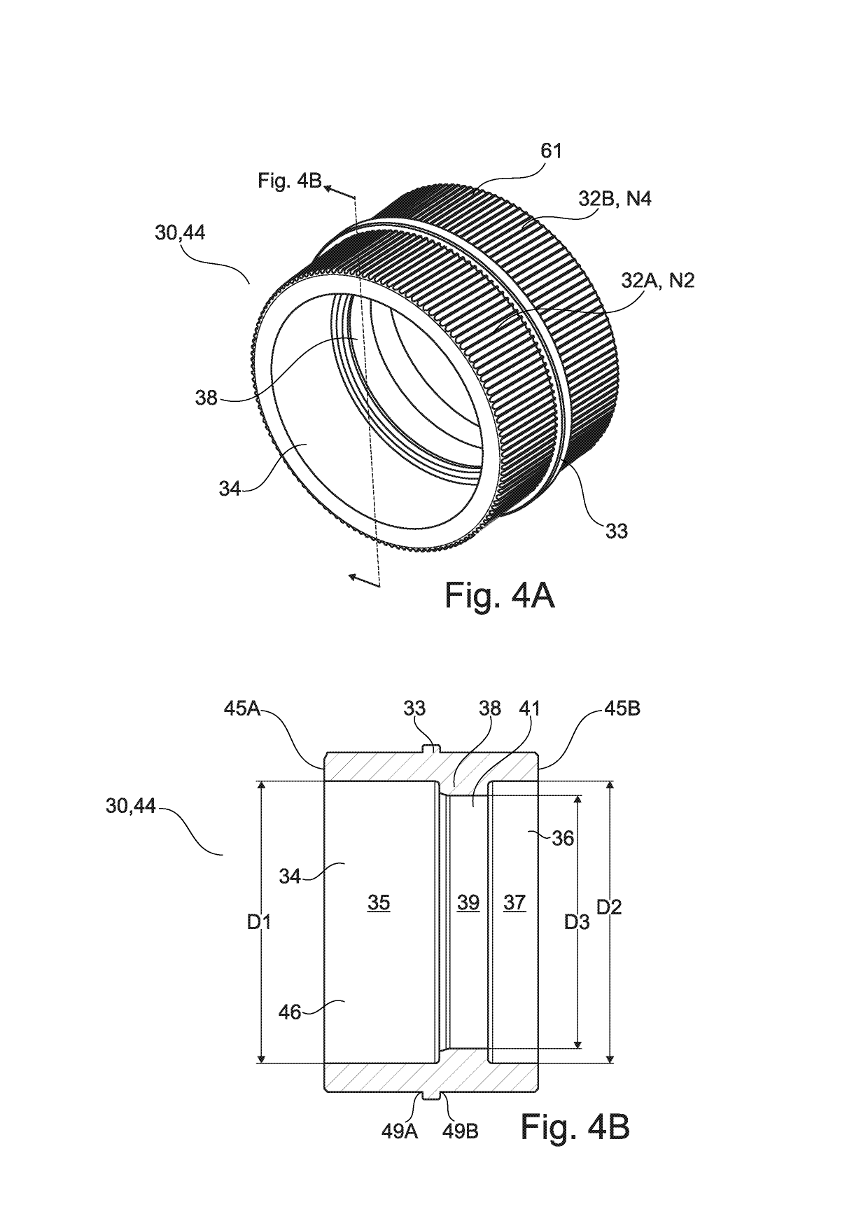

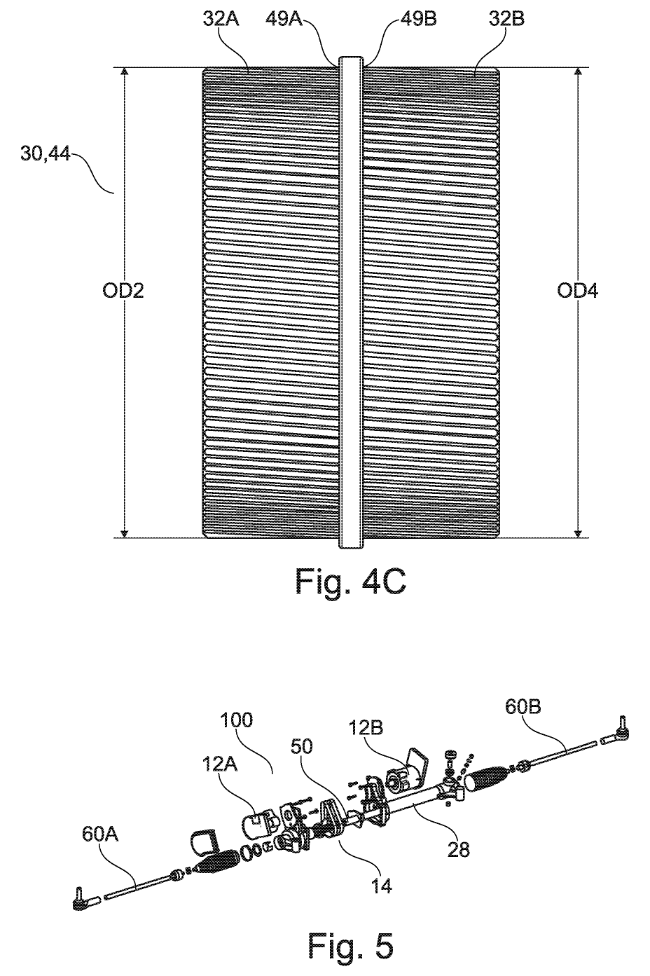

FIG. 1 is a cross-sectional view of an example embodiment of a vehicle steering system 100 for a steer by wire vehicle. FIG. 2 is a detailed view taken from FIG. 1. FIG. 3 is a perspective view of a transmission 14 incorporated within the vehicle steering system 100. FIG. 4A is a perspective view of a dual-toothed wheel 30 of the transmission 14. FIG. 4B is a cross-sectional view of the dual-toothed wheel 30 taken from FIG. 4A. FIG. 4C is a front view of the dual-toothed wheel 30 of FIG. 4A. FIG. 5 is an exploded perspective view of the vehicle steering system 100. The following should be read in light of FIGS. 1 through 5.

The vehicle steering system 100 incorporates a dual drive system 80 that includes a first electric motor 10A (or first actuator) and a second electric motor 10B (or second actuator) that rotatably drives a threaded nut 16 via the transmission 14. The threaded nut 16 threadably engages threads 54 of a threaded spindle 50 to convert rotary motion of the electric motors in either a first rotary direction R1 or a second rotary direction R2, to linear movement of the threaded spindle 50 in either a first axial direction AD1 or a second axial direction AD2 along a longitudinal axis AX1. The threaded nut 16, transmission 14, and threaded spindle 50 are arranged within a housing 28. The threaded spindle 50 is supported by a rack bushing 52 arranged within the housing 28. The threaded nut 16 is supported by a rolling element bearing 18 arranged within the housing 28. The threaded spindle 16 has a first end 56A operatively connected to a first tie rod 60A and a second end 56B operatively connected to a second tie rod 60B. Each tie rod end is coupled to a corresponding wheel assembly; thus, linear movement of the threaded spindle 50 provides steering of the wheels of a vehicle as known in the art of steering systems.

An anti-rotation device 70 may be disposed within the housing 28 proximate to a second end 56B of the threaded spindle 50. The anti-rotation device 70 prevents rotation of the threaded spindle 50 relative to the longitudinal axis AX1. Any suitable anti-rotation device can be utilized other than what is shown in FIG. 1. Further, the anti-rotation device 70 can be arranged at any suitable location along a longitudinal length of the threaded spindle 50.

In an example embodiment, the threaded nut 16 is a ball nut, known within steering systems, that utilizes a plurality of balls 23 arranged between the threads of the ball nut and the threads 54 of the threaded spindle 50. Other suitable screw systems could also be applied to the vehicle steering system 100. In an example embodiment, the threaded nut 16 includes a ball recirculation system 17 that is disposed radially outwardly of a tubular portion 40 of the threaded nut 16. The tubular portion 40 may be integral with an inner ring 62 of the rolling element bearing 18. The dual-toothed wheel 30 circumferentially houses at least a portion of the ball recirculation system 17. As shown in FIG. 2, the threaded nut 16 (or bearing thereof) is installed in the housing 28 and supported via a spacer 19, a disc spring 20, and a washer 21 on one side of the rolling element bearing 18, and a locking ring 22 on an opposite side.

The transmission 14 transmits rotational motion of the first and second electric motors 10A, 10B to the threaded nut 16 via a first toothed wheel 12A, a second toothed wheel 12B, a first endless drive band 13A, a second endless drive band 13B, and the dual-toothed wheel 30. The first and second toothed wheels 12A, 12B may be classified as “driver wheels” and the dual-toothed wheel 30 may be classified as a “driven” wheel. The threaded nut 16 is disposed within and fixed to the dual-toothed wheel 30. The first and second toothed driver wheels 12A, 12B and the dual-toothed wheel 30 could also be referred to as transmission wheels. The first toothed driver wheel 12A is fixed to a shaft 11A of the first electric motor 10A, and the second toothed driver wheel 12B is fixed to a shaft 11B of the second electric motor 10B. The transmission 14 implements a speed reduction so that a lower speed is translated from the first and second electric motors 10A, 10B to the threaded nut 16 via the dual-toothed wheel 30.

In an example embodiment, the transmission 14 is a belt drive 31 and the first toothed driver wheel 12A is a first toothed pulley 42A; the second toothed driver wheel 12B is a second toothed pulley 42B; the first endless drive band 13A is a first belt 15A; the second endless drive band 13B is a second belt 15B; and the dual-toothed wheel 30 is a dual-toothed pulley 44. The three pulleys 42A, 42B, 44 could be described as cross-tooth pulleys due to the presence of respective axially extending teeth. In a further aspect, the first and second belts 15A, 15B may be toothed belts with respective axially extending teeth 48A, 48B; therefore, the first and second belts 15A, 15B could be described as cross-tooth belts.

The first belt 15A includes the first belt teeth 48A that rotatably engage first drive teeth 64A of the first toothed pulley 42A and first driven teeth 32A of the dual-toothed pulley 44. The second belt 15B includes the second belt teeth 48B that rotatably engage second drive teeth 64B of the second toothed pulley 42B and second driven teeth 32B of the dual-toothed pulley 44. The first drive teeth 64A, which could also be referred to as a first plurality of drive teeth, extend circumferentially around the first toothed pulley 42A; and, the second drive teeth 64B, which could also be referred to as a second plurality of drive teeth, extend circumferentially around the second toothed pulley 42B. The first driven teeth 32A, which could also be referred to as a first plurality of driven teeth, extend circumferentially around the dual-toothed pulley 44; and, the second driven teeth 32B, which could also be referred to as a second plurality of driven teeth, extend circumferentially around the dual toothed pulley 44. In an example embodiment, during normal intended use, no relative rotational slippage occurs between the first and second belts 15A, 15B and the respective first and second toothed pulleys 42A, 42B and the dual-toothed pulley 44.

Given that the transmission 14 translates a reduction of the speed of the first and second electric motors 10A, 10B to the threaded nut 16, diameter ratios are present between the first and second toothed pulleys 42A, 42B and the dual-toothed pulley 44. The first driver teeth 64A on the first toothed pulley 42A define a first outer diameter OD1 and the first driven teeth 32A on the dual-toothed pulley 44 define a second outer diameter OD2 that is greater than the first outer diameter OD1. Correspondingly, a number N1 of the first drive teeth 64A of the first toothed pulley 42A is less than a number N2 of the first driven teeth 32A of the dual-toothed pulley 44. Likewise, the second driver teeth 64B on the second toothed pulley 42B define a third outer diameter OD3 and the second driven teeth 32B on the dual-toothed pulley 44 define a fourth outer diameter OD4 that is greater than the third outer diameter OD3. Correspondingly, a number N3 of the second drive teeth 64B of the second toothed pulley 42B is less than a number N4 of the second driven teeth 32B of the dual-toothed pulley 44. In an example embodiment, the number N1 of the first drive teeth 64A is equal to the number N3 of the second drive teeth 64B, and the number N2 of the first driven teeth 32A is equal to the number N4 of the second driven teeth 32B. Further example embodiments of the transmission 14 may employ different relative diameter and number of teeth relationships than what is described above.

The dual-toothed pulley 44 includes the first driven teeth 32A that are arranged at (or extend from) a first end 45A of a tubular body 47, and the second driven teeth 32B that are arranged at (or extend from) a second end 45B of the tubular body 47. The tubular body 47 defines a through-bore 46. The through-bore 46 includes: a first bore 34 that extends axially from the first end 45A of the tubular body 47 to a medial axial position of the tubular body 47; a second bore 36 that extends axially from the second end 45B of the tubular body 47 to a medial axial position of the tubular body 47; and, a third bore 41 that separates the first bore 34 from the second bore 36. The third bore 41 is defined by a diameter D3 that is less than a diameter D1 of the first bore 34 and less than a diameter D2 of the second bore 36 such that the third bore 41 forms a radially inwardly extending step 38. The diameter D1 of the first bore 34 may be the same as the diameter D2 of the second bore 36. Together, the first, second, and third bores 34, 36, 41 define the through-bore 46 of the dual-toothed pulley 44. The threaded spindle 50 movably extends through the through-bore 46. The threaded nut 16 is disposed partially within (or inside of) the through-bore 46 and partially outside of the through-bore 46. The threaded nut 16 and the ball recirculation system 17 extend out of the first end 45A of the dual-toothed pulley 44.

The first bore 34 is defined by a radial inner surface 35; the second bore 36 is defined by a radial inner surface 37; and the third bore 41 is defined by a radial inner surface 39. The radial inner surface 39 of the third bore 41 serves as a fixing surface for the threaded nut 16. In an example embodiment, a flange 57 of the threaded nut 16 is pressed into the third bore 41 so that the dual-toothed pulley 44 and the threaded nut 16 rotate in unison about the longitudinal axis AX1. In an example embodiment, an outer diameter of the flange 57 and the radial inner surface 39 of the third bore 41 form an interference fit. Other suitable ways of fixing the threaded nut 16 to the dual-toothed pulley 44 are also possible.

The second bore 36 of the dual-toothed pulley 44 fixedly receives a position sensor target 24. That is, the position sensor target 24 is disposed at least partially within the second bore 36 such that the position sensor target 24 is fixed to the second bore 36 via a press-fit or any other suitable fixing means. At least a portion of the position sensor target 24 may be circumferentially surrounded or encased by the dual-toothed pulley 44, and a remaining portion of the position sensor target 24 may extend axially outwardly from the second end 45B of the dual-toothed pulley 44. The position sensor target 24 may be any suitable position sensor target. In an example embodiment, the position sensor target 24 is an inductive position sensor target. Axially adjacent to the position sensor target 24 is an inductive position sensor 26, which monitors a rotational position of the threaded nut 16. The inductive position sensor 26 may be a single-turn inductive position sensor or a multiple-turn inductive position sensor.

In light of the above discussion, the first driven teeth 32A of the dual-toothed pulley 44 may circumscribe, house, or be proximate to the ball recirculation system 17. Further, the second drive teeth 32B of the dual-toothed pulley may circumscribe, house, or be proximate to the position sensor target 24.

The dual-toothed pulley 44 includes an axial belt stop 33 in the form of a radially outwardly extending ring or flange. The axial belt stop 33 is positioned axially between the first driven teeth 32A and the second driven teeth 32B of the dual-toothed pulley 44. In an example embodiment, the first driven teeth 32A extend axially from the first end 45A of the dual-toothed pulley 44 and terminate at the axial belt stop 33. The second driven teeth 32B may extend axially from the second end 45B of the dual-toothed pulley 44 and terminate at the axial belt stop 33. It could be stated that the first driven teeth 32A are open at a first axially outer end (that corresponds to the first end 45A of the dual-toothed pulley 44) and closed at a second axially inner end 49A via the axial belt stop 33. Further, it could be stated that the second driven teeth 32B are open at a first axially outer end (that corresponds to the second end 45B of the dual-toothed pulley 44) and closed at a second axially inner end 49B via the axial belt stop 33. The open outer ends of the first and second driven teeth may facilitate a sliding installation of the first and second belts 15A, 15B onto the respective first and second ends 45A, 45B of the dual-toothed pulley 44. The open outer ends of the dual-toothed pulley 44 are without radially outwardly extending flanges, defining a “flangeless” embodiment. Thus, the first belt 15A may be slidably installed in the first axial direction AD1 onto the first end 45A of the dual-toothed pulley 44 such that the first belt teeth 48A slidably engage the first driven teeth 32A; and the second belt 15B may be slidably installed in the second axial direction AD2 onto the second end 45B of the dual-toothed pulley 44 such that the second belt teeth 48B slidably engage the second driven teeth 32B. In other example embodiments, flanges may be present at one or both ends of the dual-toothed pulley 44.

The first and second driven teeth 32A, 32B may vary from what is described above and shown in the figures. For example, the teeth may not terminate at either of the first end 45A, the second end, 45B, or the axial belt stop 33, for manufacturing, assembly, or functional purposes. Instead, the teeth may terminate before the distal ends of the first and second ends 45A, 45B and the axial belt stop 33 to facilitate the presence of undercuts or other necessary features.

The tubular body 47 of the dual-toothed pulley 44 may be monolithic in structure. The first and second driven teeth 32A, 32B may be machined or formed directly onto the tubular body 47; thus, the tubular body 47 and teeth thereof may be monolithically constructed. In an example embodiment, the first and second driven teeth 32A, 32B may be formed on separate rings that are fixed to each end of the tubular body 47. Regardless of the one-piece or multi-piece construction of the dual-toothed pulley 44, the first driven teeth 32A and the second driven teeth 32B may be fixed to the same tubular body 47, or to a same assembly of components of the dual-toothed pulley 44.

In some example embodiments, the axial belt stop 33 may also be referred to as a non-driven land. The term “non-driven” implies that the land is not configured to rotatably engage either of the first and second belts 15A, 15B; or, stated otherwise, the term “non-driven” implies that the land is not configured to transmit torque. In an example embodiment, the non-driven land may be installed as a separate component and disposed on or around a continuous toothing that is arranged on the toothed outer surface 61, the continuous toothing extending between the first end 45A and the second end 45B of the tubular body 47. In such an instance, the non-driven land may divide the continuous toothing into two toothed portions that include the first and second driven teeth 32A, 32B. In an example embodiment, the non-driven land may be installed as a separate component and disposed between the first driven teeth 32A and the second driven teeth 32B. In an example embodiment, the non-driven land is formed monolithically with the tubular body 47.

The term “non-driven land” may also be used to describe any axially extending surface disposed between the first driven teeth 32A and the second driven teeth 32B (smooth, toothless, or otherwise) that is not designed to transmit torque. This axially extending surface may have any suitable outer diameter and does not need to be flange-like such that it protrudes radially outwardly from the tubular body 47. In an example embodiment, an outer diameter of the toothless surface is proximate to an outer diameter of the first and second driven teeth 32A, 32B, or a pitch circle thereof. In a further aspect, since such a non-driven land may terminate each of the first driven teeth 32A and the second driven teeth 32B (or a radially inner portion thereof), the non-driven land may also serve to limit axial movement of the first and second belts 15A, 15B.

The first toothed pulley 42A may include a flange 43A on an axial outer end to serve as an axial stop for the first belt 15A, but may not include a flange on an axial inner end; likewise, the second toothed pulley 42B may include a flange 43B on an axial outer end to serve as an axial stop for the second belt 15B, but may not include a flange on an axial inner end. Therefore, the first belt 15A may be prevented from moving or sliding off the belt drive 31 in the first axial direction AD1 via the axial belt stop 33, and in the second axial direction AD2 via the flange 43A. Correspondingly, the second belt 15B may be prevented from moving or sliding off the belt drive 31 in the first axial direction AD1 via the flange 43B, and in the second axial direction AD2 via the axial belt stop 33.

Thus, the axial belt stop 33 serves as a stop for both the first belt 15A and the second belt 15B such that it limits axial movement of the first belt 15A and the second belt 15B. In a further example embodiment, separate belt stops may be disposed on the dual-toothed pulley 44, with one of the separate belt stops independently serving as a stop for the first belt 15A and another one of the separate belt stops independently serving as a stop for the second belt 15B.

In an example embodiment, the first and second electric motors 10A, 10B are arranged such that their respective first and second motor shafts 11A, 11B are concentric to first and second rotational axes RA1, RA2 which are collinear to each other. Likewise, the corresponding first toothed pulley 42A and the second toothed pulley 42B of the first and second electric motors 10A, 10B are concentrically arranged in an axially adjacent arrangement.

In an example embodiment, the first and second electric motors 10A, 10B are arranged such that their rotational axes RA1, RA2 are parallel, but not collinear to each other.

The first endless drive band 13A and the second endless drive band 13B may be any suitable drive band other than a belt, and the dual-toothed wheel 30 can incorporate any suitable drive band interface other than the shown and described cross-toothed arrangements. For example, chains instead of belts may be utilized and the first and second toothed driver wheels 12A, 12B may be chain sprockets and the dual-toothed wheel 30 may incorporate an arrangement of first driven sprocket teeth and an arrangement of second driven sprocket teeth.

The vehicle steering system 100 described herein may incorporate different designs and operating strategies. In an example embodiment, the vehicle steering system 100 provides redundancy such that in case of a failure of one of the first or second electric motors 10A, 10B and/or one of the first or second endless drive bands 13A, 13B, the other electric motor and corresponding drive band will solely provide torque to the threaded nut 16 for linear displacement of the threaded spindle 50. Therefore, each of the first or second electric motor 10A, 10B may solely provide full steering functionality for the vehicle. In an example embodiment, the first and second electric motors 10A, 10B together provide a required torque to actuate the threaded nut 16 for linear displacement of the threaded spindle 50. This supplemental power arrangement allows for a reduced packaging size of the first and second electric motors 10A, 10B. In an example embodiment, each of the first and second electric motors 10A, 10B is designed to provide unequal torques to actuate the threaded nut 16 for linear displacement of the threaded spindle 50. In an example embodiment, the vehicle steering system 100 has: i) a first driving state in which the threaded nut 16 (or dual-toothed pulley 30 attached thereto) only receives torque from one of the first electric motor 10A or the second electric motor 10B, and ii) a second driving state in which the threaded nut 16 (or dual-toothed pulley 30 attached thereto) receives torque from both the first motor 10A and the second motor 10B.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle steering system, comprising:
a first actuator drivably connected to a threaded nut;
a second actuator drivably connected to the threaded nut;
a threaded spindle configured to move linearly along a first axis via rotation of the threaded nut;
a transmission wheel fixed to the threaded nut such that the transmission wheel and the threaded nut rotate in unison about the first axis;
a first endless drive band rotatably connecting the first actuator to the transmission wheel;
a second endless drive band rotatably connecting the second actuator to the transmission wheel; and
at least one endless drive band stop disposed on the transmission wheel axially between the first endless drive band and the second endless drive band, the at least one endless drive band stop configured to limit axial movement of the first endless drive band and/or the second endless drive band on the transmission wheel.

2. The vehicle steering system of claim 1, wherein the transmission wheel further comprises:
a first plurality of teeth extending circumferentially around the transmission wheel and drivably engaged with the first actuator via the first endless drive band; and
a second plurality of teeth extending circumferentially around the transmission wheel and drivably engaged with the second actuator via the second endless drive band.

3. The vehicle steering system of claim 2, wherein the first plurality of teeth are axially spaced from the second plurality of teeth on the transmission wheel.

4. The vehicle steering system of claim 2, wherein the at least one endless drive band stop is arranged axially between the first plurality of teeth and the second plurality of teeth.

5. The vehicle steering system of claim 1, wherein the transmission wheel further comprises a through-bore and the threaded nut is disposed partially within the through-bore and extends axially outside of the through-bore.

6. The vehicle steering system of claim 1, wherein the threaded nut is constructed in one piece with an inner raceway of a rolling element bearing.

7. The vehicle steering system of claim 1, wherein the threaded nut further comprises a ball recirculation system arranged radially between a tubular portion of the threaded nut and the transmission wheel.

8. The vehicle steering system of claim 7, wherein the transmission wheel further comprises a through-bore and the ball recirculation system is disposed partially within the through-bore and extends axially outside of the through-bore.

9. The vehicle steering system of claim 7, further comprising a position sensor target fixed to an end of the transmission wheel.

10. The vehicle steering system of claim 7, further comprising a position sensor target disposed at a first end of the transmission wheel, and the ball recirculation system is disposed at a second end of the transmission wheel.

11. A vehicle steering system, comprising:
a first actuator drivably connected to a threaded nut;
a second actuator drivably connected to the threaded nut;
a threaded spindle configured to move linearly along a first axis via rotation of the threaded nut;
a transmission wheel fixed to the threaded nut, the transmission wheel having:
a first end configured to receive a first endless drive band rotatably connecting the first actuator to the transmission wheel;
a second end configured to receive a second endless drive band rotatably connecting the first actuator to the transmission wheel; and
a tubular body circumferentially surrounding the threaded nut so as to house at least a portion of a ball recirculation system of the threaded nut.

12. The vehicle steering system of claim 11, wherein the first end of the transmission wheel and the second end of the transmission wheel are flangeless.

13. The vehicle steering system of claim 11, wherein the transmission wheel is a dual-toothed transmission wheel having a first plurality of circumferentially extending teeth and a second plurality of circumferentially extending teeth axially separated from the first plurality of circumferentially extending teeth.

14. The vehicle steering system of claim 13, wherein an axially outer end of the first plurality of circumferentially extending teeth is open and an axially inner end of the first plurality of circumferentially extending teeth is closed.

15. A vehicle steering system, comprising:
a first electric motor drivably connected to a threaded nut;
a second electric motor drivably connected to the threaded nut;
a threaded spindle configured to move linearly along a first axis via rotation of the threaded nut;
a driven pulley fixed to the threaded nut such that the driven pulley and the threaded nut rotate in unison about the first axis, the driven pulley comprising:
a tubular body;
a first plurality of teeth:
disposed on a first end of the tubular body; and
rotatably engaging a first belt so as to drivably connect the first electric motor to the driven pulley; and
a second plurality of teeth:
disposed on a second end of the tubular body; and
rotatably engaging a second belt so as to drivably connect the second electric motor to the driven pulley; and
a non-driven land disposed axially between the first plurality of teeth and the second plurality of teeth.

16. The vehicle steering system of claim 15, wherein the threaded nut is disposed within a bore of the driven pulley.

17. The vehicle steering system of claim 15, wherein the driven pulley includes a first plurality of teeth configured to rotatably engage the first belt and a second plurality of teeth, axially offset from the first plurality of teeth, configured to rotatably engage the second belt.

18. The vehicle steering system of claim 15, further comprising:
a first drive pulley fixed to the first electric motor;
a second drive pulley fixed to the second electric motor; and
the first drive pulley and the second drive pulley are configured to rotatably drive the driven pulley via the respective first belt and second belt.

19. The vehicle steering system of claim 18, wherein:
the first drive pulley includes a first stop configured to limit axial motion of the first belt in a first axial direction; and
the driven pulley includes a second stop configured to limit axial movement of the first belt in a second axial direction.

20. The vehicle steering system of claim 18, wherein a rotational axis the first drive pulley is parallel with a rotational axis of the second drive pulley.
